(19) United States
(12) Patent Application Publication
(10) Pub. No.: US 2021/0369020 A1
(43) Pub. Date: Dec. 2, 2021

(54) Alcohol Beverage and Spirits Nosing, Tasting, Drinking, and Sampling Vessel, Procedure or Method for Using Same, and a Process to Separate Ethanol Vapors from Sampling Vapors Prior to Nosing

(71) Applicants: George Manska, Las Vegas, NV (US); Christine Crnek, Henderson, NV (US)

(72) Inventors: George Manska, Las Vegas, NV (US); Christine Crnek, Henderson, NV (US)

(21) Appl. No.: 15/967,538

(22) Filed: Apr. 30, 2018

(51) Int. Cl. A47G 19/22; B01D 1/00; B01D 1/30; C12G 1/00; C12G 3/04

(52) U.S. Cl. CPC A47G 19/2205; B01D 1/0011; B01D 1/30; A47G 2400/045; C12G 3/04; A47G 19/2288; C12G 2200/25; C12G 1/00

(57) ABSTRACT

This application is for a device and article of manufacture for the purpose of drinking, tasting, sampling, and nosing and evaluating alcohol beverages without alcohol nose burn and numbing; a procedure or method to manipulate said vapors for the same purpose; and a process to separate and dissipate ethanol vapors to accomplish the same purpose. The device is one embodiment of a vessel which collects vapors in a chamber with curved sides and large surface area to promote evaporation, which chamber's top opening orifice concentrates same vapors prior to passing into an expansion chamber releasing and dissipating fast moving ethanol prior to nosing, providing improved aroma detection and enhancing nosing, tasting, and sampling experiences for all spirits, wines and liqueurs, distilled, fermented, and fortified.

### FEDERALLY SPONSORED RESEARCH

This application is not under contract with or by a United States Government Agency. No government assistance, grant funding or Federal sponsored research was used.

### BACKGROUND

This application refers to: a vessel for sampling, tasting, nosing, and evaluating beverages containing ethanol; a procedure or method for sampling, tasting, nosing, and evaluating beverages containing ethanol; and a process and means to selectively separate the vapors and aromas of ethanol from the other aromas of liquids and beverages for the purpose of drinking, tasting, sampling, smelling, and nosing beverages or liquids containing ethanol alcohol.

### PRIOR ART

TABLE-US-00001 [0003] Classifi-Type Pat. No. cations Patent Date Patentee U.S. Pat. No. 6,189,715 B1 215/374 Feb. 20, 2001 Dubois Pat. No. U.S. Pat. No. 2,143,027 N/A Jan. 10, 1939 Perry Pat. No. Design D575,108 S D7/523; Aug. 19, 2008 Musso et al. D7/524; D7/509 Design D569,189 S D7/523; May 20, 2008 Kehrein et al. D7/509 Design D555,429 S D7/523; Nov. 20, 2007 Lipson D7/524 Design D548,528 S D7/523; Aug. 14, 2007 Cha et al. D7/509 Design D544,306 S D7/524; Jun. 12, 2007 Festa D7/300.1 Design D543,786 S D7/524 Jun. 5, 2007 Walsh Design D535,558 S D9/440 Jan. 23, 2007 Kehoe et al. Design D515,927 D9/503; Feb. 28, 2006 Smay et al. D7/615 Design D495,210 D7/524; Aug. 31, 2004 Rosow D7/537 Design D459,156 S D7/524; Jun. 25, 2002 Davidson D7/523; D7/509 Design D156,921 S N/A Jan. 17, 1950 Sloan

### DISCUSSION OF PRIOR ART

Source of Ethanol in Beverages: Ethanol is a component of all alcohol beverages and is present in wines and spirits as a by-product of distillation and fermentation, or by fortification or addition of ethanol to an existing beverage.

Physiological Effects of Ethanol: The pungent odor of ethanol obscures many subtle odorant aromas of distilled, fermented, fortified, and barrel aged alcohol beverages and spirits. Ethanol is neuropathological and can cause damage and eventual neuron death to olfactory neuron receptors from overexposure. Ethanol causes an unpleasant nose burn sensation, as well as a numbing and anesthesia of olfactory neuron receptors. Hyposmia is a reduced ability to smell and detect odors, and increases with age. Removing olfactory ethanol becomes a factor in olfactory appreciation of alcohol beverages in aging tasters, samplers, nosers and evaluators who have experienced a natural loss of olfactory perception since birth.

Tasting and Nosing as Evaluation Tools: Tasting and nosing evaluations of alcohol beverage samples are the common method of quantifying flavor for personal enjoyment, pricing, marketing, demand, collectability, production quality control, and competitive judgment. Flavor is the interaction of smell and taste. Although neural processing of odors and aromas is not yet fully understood, it is generally accepted that five basic tongue tastes, sweet, sour, salty, bitter, and amame, work in concert with a thousand or more discernible aromas to form flavor perception. The potential of nosing and tasting to evaluate flavor are severely limited by strong, overpowering, numbing ethanol.

Evaporation: Evaporation is a result of molecular collision within a liquid or beverage imparting energy to molecules to break through liquid surface tension. Continual evaporation creates vapor pressure which drives odorants upward with a natural tendency to expand. Evaporated odorants have various molecular weights and shapes, and move at different velocities. Ethanol is one of the lightest and most prevalent odorants in an alcohol beverage, and evaporates faster than most odorant molecules.

The Role of Evaporation in Tasting and Nosing: Evaporation is the natural, physical process which presents odorants and aromas to the olfactory neuron receptors for evaluation. Evaporation increases with temperature, mixing or agitation or swirling, and with increased evaporative surface area. Vessel shape is an aid to enhancing and increasing evaporation if said shape facilitates controlled hand warming or temperature control, swirling by mixing and agitation, and provides adequate evaporation area.

Vessel Height Effect on Aroma Sample Quality: Ethanol is among the lightest and simplest molecular shapes of odorants in an alcohol beverage. Many other odorants have heavy molecular weights, larger molecular size, and complex molecular shapes which hinder upward movement to reach the rims of tall vessels. Heavier odorants fall back into the liquid escaping olfactory evaluation. Vessel height becomes a factor in providing representational odorant sample characteristics. Vessels with rim location higher than 4.5 centimeters above the evaporative surface of the beverage present an odorant sample over weighted with ethanol. Ethanol as a percentage of all odorants increases at higher rim heights, as heavier molecules return to the liquid. Odorant samples are further over weight with ethanol when coupled to narrow, columnar, chimney type vessel shapes which embody small evaporation surface areas.

Background of the Vessel

Shape: Existing vessel shape accomplishes two functions; to hold the beverage to be sampled, and to provide a method to position the human mouth to receive the beverage as it leaves the vessel. Nosers, samplers, and tasters select existing vessels subjectively to present olfactory and gustatory characteristics of the alcohol beverage for evaluation with little or no consideration of evaporative and molecular science.

Proliferation of Shapes: Many similar vessel shapes exist due to marketing attempts to persuade shape identification to a particular beverage source, geographic area, or grape varietal. Most common shapes relate to eye appeal and attractive style with some ergonomic considerations such as length of stem and bowl size, but with little or no consideration of physical properties of the beverage odorant sample.

Patentability of Commonly Used Vessels: The emphasis on vessel design eye appeal has led to heavy utilization of the design patent process. Few vessel patents make claims of utility, and common marketing practices present many unsubstantiated claims as to utility. Future study and application of science can lead to more vessel utility patents.

State of Technology Vessel Design—Convergent Rim: Convergent rim is the most common vessel design and describes a vessel with or without stem and foot, consisting of a bowl to hold the beverage, and sides that converge to a smaller opening area than the widest area of the bowl, concentrating odorants in a convenient location for olfactory detection prior to escape into the atmosphere. Ethanol aromas which obscure and dominate subtler odorants and aromas are also concentrated into the same location.

A snifter is a convergent rim vessel with a large bowl to facilitate evaporation with proportionally large beverage evaporation surface area. Large bowl size permits incoming air to dilute but not dissipate ethanol. Ethanol aroma becomes evident and detectable as vapor pressure causes odorants to rise to the vessel rim. Snifters allow the nose to enter the vessel top opening to sample all diluted odorants and aromas including ethanol.

During beverage transfer to the palate, convergent rim vessels concentrate the pour into a fine stream which generally falls onto the forward portion of the tongue, resulting in less taste bud coverage at initial contact on the palate, and a narrow flavor perception.

State of Technology Vessel Design—Vertical Sides: Straight, vertical or nearly vertical side vessels provide the same or nearly the same cross sectional area at the rim plane as at the evaporative surface plane. Such vessel design relies on incoming air to dilute but not dissipate ethanol, operating similar to said snifter without a concentration feature.

State of Technology Vessel Design—Divergent Sides: Divergent vessel sides permit air to mix with the odorants of the beverage and dilute the smell of the alcohol as well as other odorants. Divergent side vessels are unstable for drinking and spill easily from the sides of the mouth when tilted, due to divergent rim geometry. The common Martini glass is an example of a divergent side vessel. Divergent side vessels also have a propensity to spill during handling, due to their divergent sides presenting a gradual ramp for beverage movement unless steady handling is employed. Divergent side vessels are not a frequent choice for nosing and sampling due to handling instabilities and lack of functional aromatic features for nosing and tasting.

During beverage transfer to the palate, divergent rim vessels expand the pour from a fine stream into a sheet waterfall which falls across the entire tongue width, resulting in greater taste bud coverage at initial contact and broadening flavor perception.

Vessel utility patents exist, however, none are utility patented as an ALCOHOL BEVERAGE AND SPIRITS NOSING, TASTING, DRINKING AND SAMPLING VESSEL, or nearly similar designation, use, or function and most vessels are design patented.

U.S. Pat. No. 6,189,715 B1, a utility patent by Dubois, Snifter for Alcoholic Beverages Such as Brandy, Spirits and Liquors, granted Feb. 20, 2001 alleviates some nose burn from ethanol by diluting odorants with a large volume of air in the evaporation chamber. Major drawbacks of the snifter are dilution but not dissipation, and low recommended fill line restricting evaporative surface to a small area compared to larger diameters of the evaporation chamber. The recommended fill line for one embodiment also limits the amount of spirit for a single serving. These parameters slightly reduce ethanol, as well as all other odorants. The inventor recommends sipping the beverage through a straw which is unacceptable to many alcohol beverage drinkers.

Two design patented vessels are commonly used and marketed as tasting vessels; specifically, D543,786 S by Davidson, granted Jun. 5, 2007, and D459,156 S by Walsh, granted Jun. 25, 2002. Said references have limited surface area to promote evaporation by swirling, both have narrow opening areas which concentrate all odorants, including overpowering ethanol obscuring subtle odorant aromas, both embody rim heights higher than the effective limit for providing accurate representational odorant nosing samples, and both provide narrow pour stream to the palate resulting in narrow flavor profile, although the Walsh reference is slightly improved over the Davidson reference.

Other prior art references are design patents which embody design shape similarity to the application, and for which no functional or utility claims have been made and would not meet aforementioned criteria for an adequate nosing and sampling vessel.

Tasting, nosing, and sampling, is the evaluation process of collectors, connoisseurs, judges, aficionados, and consumers, and is the basis for industry demand, pricing, production, and marketing. Evaluation tool choice is determined from existing vessels marketed as tasting and evaluation vessels without verifiable effectiveness, functional claims or design consideration of the physiology of evaporation and odorant properties.

Background of the Procedure or Method

Procedures Developed to Reduce Ethanol Effects—Vessel Proximity to the Nose: Physical procedures and techniques have been developed to reduce ethanol effects on the olfactory system for particular existing vessel shapes.

One procedure used with tall rim and convergent rim vessels is to hold the vessel about 10-30 cm from the nose and waft the vapors toward the nose with successive hand waves while slowly inhaling to gradually acclimate olfactory sensors to ethanol prior to nosing.

Another procedure involves placing a beverage liquid sample into the oral cavity prior to olfactory sampling and holding while saliva mixes with the beverage, raising beverage surface tension providing some hydrogen bonding to ethanol to slow evaporation. The mixture is then swallowed and air drawn in to the mouth over the palate to pick up the odorant sample through the pharyngeal passage to the olfactory neuron receptors.

Using another procedure for convergent rim shapes, the nose is slowly brought closer to the glass in each of three successive approaches as slow and deliberate inhalation takes place to gradually acclimate the olfactory sensors to ethanol.

Procedures Developed to Reduce Ethanol Effects—Adding Elements to Slow Evaporation: Adding water or ice cubes shuts down evaporation by raising surface tension. Adding chilled “stones”, marbles, or ceramic chips lowers temperature and slows evaporation, decreasing odorant aroma detection. Evaporation of ethanol and all odorants is slowed when adding water, ice, or chilled stones.

Procedures Developed to Reduce Ethanol Effects—Temperature Control: Hand warming elevates beverage temperature to increase evaporation of odorants, and is dependent upon vessel shape, since many vessels fail to provide sufficient hand heat transfer area and are awkward to hold. The large, globular foot on the vessel described in U.S. Pat. D543,7865 by Davidson, granted Jun. 5, 2007, serves as a heat sink, soaking up hand heat prior to beverage warming, increasing time required to raise temperature to improve evaporation. The short stemmed D459,1565 by Walsh, granted Jun. 25, 2002, forces the user to hold the vessel on stem and bowl simultaneously, providing very little area for hand heat transfer and affecting visual evaluation due to skin color refraction.

Procedures Developed to Reduce Ethanol Effects—Swirling: Swirling is a procedure to mix and agitate the beverage to enhance aeration and evaporation. Swirling wets the inside of the vessel sides and increases dynamic evaporation surface area.

Procedures Developed to Reduce Ethanol Effects—Breathing: Opening the mouth when inhaling decreases nasal suction and allows outside air to enter the oral cavity and mix with air inside the olfactory chamber through the pharyngeal passage, reducing ethanol nose burn. The favored approach when smelling food, flowers, and perfume, is to inhale through the nose with closed mouth to ensure detection of all subtle aromas and odorants. Inhaling alcohol spirits in small opening, convergent rim glasses with mouth closed will cause alcohol nasal burn, anesthetic numbing, and destroy olfactory ability to smell subtle aromas and odorants.

Many procedure or method patents exist, however there are none specifically utility patented as a PROCEDURE OR METHOD FOR USING AN ALCOHOL BEVERAGE AND SPIRITS NOSING, TASTING, DRINKING AND SAMPLING VESSEL, or nearly similar designation, use, or function.

Common procedures have evolved from existing, inadequate tasting, nosing, and sampling vessels based on traditional convergent rim theory, or attractive appearance. Said procedures reflect attempts to improve performance of the existing vessel. No known vessels eliminate stop-gap procedures and functionally improve tasting, sampling, and nosing using a specific employment procedure.

Background of the Process

Processes formulated to utilize physical differentials between odorants and aromas, or to manipulate the physical process of evaporation to promote separation of ethanol are unknown. Known processes are limited to two lines of reasoning: first, to collect all odorants close to the nasal passage openings with a convergent rim to hinder aroma and odorant escape prior to odorant sampling, relying on the olfactory organ to select and differentiate ethanol from other collected aromas; second, to provide a convergent rim with large bowl and evaporation area such as a snifter, to dilute ethanol vapors by allowing outside air to mix with the collected odorants, diminishing but not dissipating ethanol aromas prior to nosing, and simultaneously diluting other odorants.

Many process patents exist, none utility patented as a PROCESS TO SEPARATE ETHANOL VAPORS FROM SAMPLING VAPORS PRIOR TO NOSING, or nearly similar designation, use, or function.

### SUMMARY

The vessel utilizes physical shape to separate ethanol alcohol from other characteristic beverage aromas and odorants resulting in a detectable, distinctive, discernible, memorable olfactory and gustatory sample unhindered by the strong scent of ethanol.

The vessel also can be used to sample, blend, and evaluate perfumes, eau de toilettes, colognes, fragrances, scents and oils without strong overpowering ethanol.

The procedure or method for employing the vessel further assures dissipation of ethanol aromas and provides improved, discernible, and intense odorant samples for evaluation.

The process of manipulating odorants by concentration then expansion through an orifice by vapor pressure separates the ethanol alcohol aromas from other odorant aromas.

### DRAWINGS—FIGURES

FIG. 1 depicts an elevation view of the first embodiment of the vessel

FIG. 2 depicts a bottom view of the first embodiment of the vessel.

FIG. 3 depicts a top view of the first embodiment of the vessel

FIG. 4 depicts a section view of the elevation of the first embodiment of the vessel

FIG. 5 depicts a section view of the vessel showing element reference numbers

FIG. 6 depicts a perspective view of the vessel showing a typical vessel bowl fill and a generalized location and proximity of the sweet spot.

FIG. 7 depicts a section view of the vessel showing a typical vessel bowl fill and a generalized location and proximity of the sweet spot.

FIG. 8 depicts a perspective view of the vessel showing the location of the evaporation chamber.

FIG. 9 depicts a section view of the vessel showing the location of the evaporation chamber.

FIG. 10 depicts a perspective view of the vessel showing the location of the evaporative expansion chamber.

FIG. 11 depicts a section view of the vessel showing the location of the evaporative expansion chamber.

FIG. 12 depicts a top view of an embodiment of the vessel with stem and foot.

FIG. 13 depicts a sectional view of the side view of an embodiment of the vessel with stem and foot.

FIG. 14 depicts a side view of an embodiment of the vessel with stem and foot.

FIG. 15 depicts a bottom view of an embodiment of the vessel with stem and foot

FIG. 16 depicts the vessel in a perspective view.

FIG. 17 depicts an embodiment of the vessel with an optional cup handle.

FIG. 18 depicts the vessel with an optional watch glass cover embodiment and optional ornamental cover embodiment.

FIG. 19 depicts the vessel in a double-wall insulated embodiment.

FIG. 20 depicts an embodiment of the vessel with an interior bottom hump, punt, or kick to promote aeration during the fill pour and add additional evaporative surface area.

FIG. 21 depicts an embodiment of the vessel with ridges to enhance aeration.

FIG. 22 depicts a section of the rim of FIG. 21 with ridges added to the inside surface of the expansion chamber to enhance aeration while drinking.

FIG. 23 depicts an alternate section to FIG. 22 to with bumps added to the inside surface of the expansion chamber to enhance aeration.

### GLOSSARY OF TERMS

Ethanol refers herein to common edible alcohol prominent in many liquid beverages, common chemical symbol C.sub.2H.sub.5 (OH). Sometimes referred to as ethyl alcohol, grain alcohol, drinking alcohol, and pure alcohol, ethanol and alcohol are used interchangeably.

Evaporation chamber or collection chamber is herein defined as the spatial volume directly above the beverage liquid surface area into which evaporated odorants are collected before being forced out by vapor pressure. The collection chamber is bounded by divergent vessel sides, beverage surface area, and the orifice.

Evaporation equilibrium is achieved when an open ended vessel is covered and allowed to stand until the evaporated vapors are at a maximum density, and as many evaporated molecules are arising from the liquid surface as are returning to the liquid surface. When equilibrium is achieved, the noser removes the cover, quickly placing the beverage in the proximity of the nose to sample the odorants at maximum density.

Evaporative expansion chamber is herein defined as the spatial volume directly above the vessel orifice into which the evaporated odorants pass after they cross the orifice plane, and is bounded by divergent rim sides, the orifice, and rim plane, beyond which rim plane ethanol aromas dissipate into the atmosphere.

Evaporative surface plane is herein defined as a two dimensional plane which contains the static evaporative surface area, and is parallel to the rim and orifice planes.

Evaporative surface area is herein defined in the vessel at rest static state as the beverage surface area, from which odorants evaporate, located in the evaporative surface plane; and defined in the dynamic state which occurs during vessel motion or swirling, as the evaporative area of the static state plus wetted surface area of the convergent sides.

Liquid sample is herein defined as the liquid being nosed, tasted, sampled, or evaluated.

Neck is herein defined as the outside of the vessel at the junction of the convergent sides of the evaporative collection chamber and the divergent sides of the evaporative expansion chamber in the plane of the internal orifice and provides a convenient grip.

Noser is herein defined as one who performs nosing as described, or gas chromatography or mass spectrometry analyzer, olfactometer, or similar apparatus.

Nosing is herein defined as the process of passing one's nose over the open end of a vessel containing a liquid while inhaling through the nostrils to present an olfactory sample to the olfactory sensors for detection, identification, or classification of odors, or aromas emanating or evaporating from said liquid, or the use of a gas chromatography or mass spectrometry analyzer or similar apparatus to accomplish said purpose.

Odorant is herein defined as a chemical compound which activates the olfactory system, defined by a specific odor or aroma. Odorant applies to liquid or aromatic form, or both.

Odorant sample is herein defined as evaporated odorant vapors.

Orifice is herein defined as the opening which connects the collection chamber with the expansion chamber, and is a restriction, being smaller in cross sectional area than the evaporative surface, which serves to concentrate odorants prior to expansion, located in the orifice plane.

Orifice plane is herein defined as a two dimensional plane which contains the area herein designated as orifice and defined by the contiguous junction between convergent sides of the collection chamber and divergent sides of the expansion chamber. The orifice plane is parallel to the rim and evaporative surface planes.

Rim lip is herein defined as the rim edge, or mouth or top opening of the vessel and is a circular area located in the rim plane. In addition, said rim lip is a convenient locator for the human mouth to aid in positioning the nose into the sweet spot for sampling.

Rim plane is herein defined as a two dimensional plane which contains the rim lip as the top terminus of the vessel divergent sides, and is parallel to the evaporative surface and the orifice planes.

Sample can refer to the liquid sample or the odorant sample, which is a vapor sample.

Sampling is herein defined as the process of nosing and tasting, and refers to the gustatory and olfactory evaluation of the beverage to determine flavor and aromas of odorants by the human olfactory system, gas chromatography or mass spectrometry analyzer, olfactometer, or similar device or procedure. Sampling, tasting and nosing are interchangeable except in the case of perfumes and scents, which are not gustatory.

Spirits are herein defined as beverages and concoctions which contain common edible ethanol alcohol from distillation or fermentation, including but not limited to whiskeys, rum, vodka, gin, tequila, liqueurs, brandy, Cognac, Armagnac, eau de vie, fortified and dessert wines, infused liquors, aperitifs, sake, and wines. Spirits also include perfumes, eau de toilettes, and scented aromas and oils which are olfactory evaluated.

Sweet Spot is herein defined as the spatial volume above the orifice in the proximity of the rim plane, from which lighter, fast moving ethanol molecules have diffused leaving slower, heavier molecule odorants to nose. The size, volume and proximity of the sweet spot depend upon odorant characteristics.

Swirling is herein defined as a physical method of mixing and agitating a beverage within a vessel by rotating continuously, deliberately, and evenly to promote continuous liquid motion and expose the beverage to atmosphere to enhance odorant evaporation.

Tasting is herein defined as a combination of olfactory nosing and odorant sampling, and transfer of the liquid sample from the vessel to the oral cavity to detect characteristics of taste (sweet, salty, sour, bitter, and amame). During tasting, odorants escape into the olfactory cavity via the pharyngeal passage, and the perceptions of smell and taste coordinate in the brain, forming a single, inseparable flavor. Tasting is olfactory and gustatory, and used interchangeably with nosing and sampling.

Whiskey is herein used interchangeably with whisky, regardless of spelling, geographical or regional preference.

### DRAWINGS—REFERENCE NUMERALS (FIG. 5)

31 evaporation chamber volume, or evaporation collection chamber, bounded by 32, 33, and 34
32 liquid or evaporative surface area
33 convergent vessel sides
34 orifice
35 expansion chamber volume bounded by 34, 36, and 37
36 divergent vessel sides
37 rim opening area
38 rim lip
39 proximity of sweet spot volume
40 neck

### Detailed Description of the First Embodiment of the Vessel

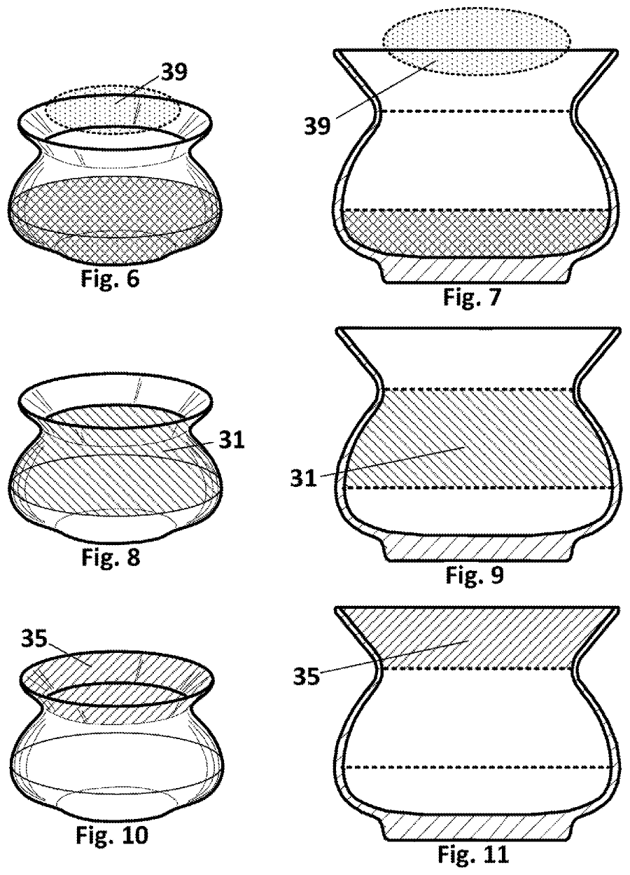

Construction of the vessel is herein described as a bowl (FIGS. 5, 6, 7), to which is attached evaporation collection chamber volume 31 (FIGS. 5, 8, 9), which collection chamber is bounded on the bottom by liquid surface area 32, bounded on the sides by convergent vessel sides 33 attached at their lower extremity to the bowl at liquid surface area 32, and bounded at the top by orifice 34. Expansion chamber volume 35 (FIGS. 5, 10, 11) is bounded on the bottom by orifice 34, located directly above said evaporation collection chamber 31, and bounded on the sides by divergent vessel sides 36, attached at their lower extremity to convergent vessel sides 33 at orifice 34, and bounded on the top by rim opening area 37, at which divergent vessel sides 36 terminate at their upper extremity to form rim lip 38.

The vessel herein described, separates and dissipates ethanol prior to nosing and olfactory evaluation and resolves said nosing problems in four distinct stages.

The evaporative stage utilizes liquid and static evaporative surface area 32 and an additional dynamic evaporation area on the wetted inside of the outwardly curved vessel sides to promote evaporation while swirling. The vessel shape exposes lower vessel bowl area in contact with the beverage to hand warming by cradling vessel bowl in the palm, enhancing evaporation of odorants and aromas to desired intensity. Gripping the vessel at neck 40 between thumb and forefinger provides cooling and prevents hand warming.

The collection stage is realized within evaporative chamber 31. Vapor pressure drives aromas and odorants upward in a natural tendency to expand. All evaporated odorants and aromas move randomly within evaporation collection chamber 31.

The concentration stage utilizes convergent sides 33 to direct odorants and aromas to orifice 34, smaller than evaporative surface 32 which concentrates all odorants and promotes molecular collision, increased vapor density, increased vapor pressure, and higher molecular velocities at orifice 34.

The expansion stage takes place in expansion chamber 35 with divergent sides 36 allowing greater degree of molecular movement. As vapor pressure forces odorants through orifice 34, lighter, faster moving ethanol molecules disperse rapidly over the edges of rim lip 38 into the atmosphere, leaving heavier, slower, odorous molecules in proximity of a sweet spot 39 for olfactory sampling. Rim lip 38 conveniently positions the nasal passage openings in proximity of the sweet spot by placing human lips on rim lip 38. Rim lip 38 geometry aids in preventing nasal passage insertion below orifice 34 into evaporative chamber volume 31, which will expose olfactory sensors to ethanol.

During tasting, the divergent rim lip 38 of the vessel delivers the pour to the palate in a wide sheet waterfall shape, broadening the flavor profile over prior art references by Walsh and Davidson by increasing taste bud exposure.

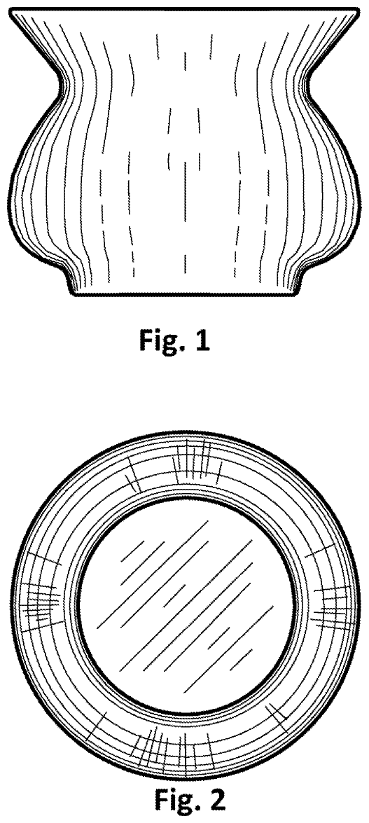

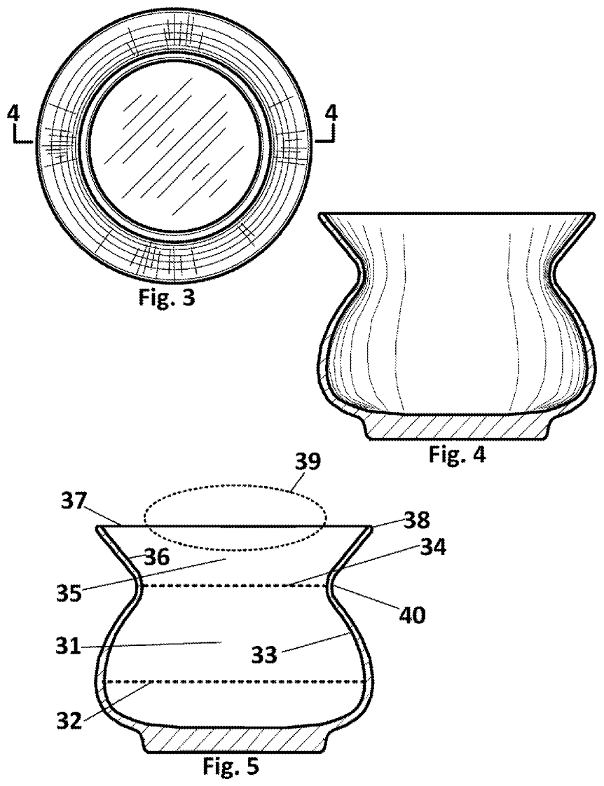

Operation of the First Embodiment of the Vessel—FIGS. 1-5

Preferred use of the vessel is to add beverage to the vessel up to the maximum horizontal diameter of the bowl at evaporative surface plane 32 while vessel sits level and upright, swirl slowly and deliberately to wet vessel sides, hold vessel level under the nose with lips touching rim lip 38 of the vessel, and tilt the head forward or backward slightly while inhaling through the nose to determine the best position to maximize olfactory sensing. User should avoid placing the nose into the vessel below orifice plane 34 since that action will result in strong odor of ethanol, numbing the olfactory sensors. Vessel bowl may be hand held to warm to desired temperature to promote evaporation, or held between thumb and forefinger at neck 40 to cool.

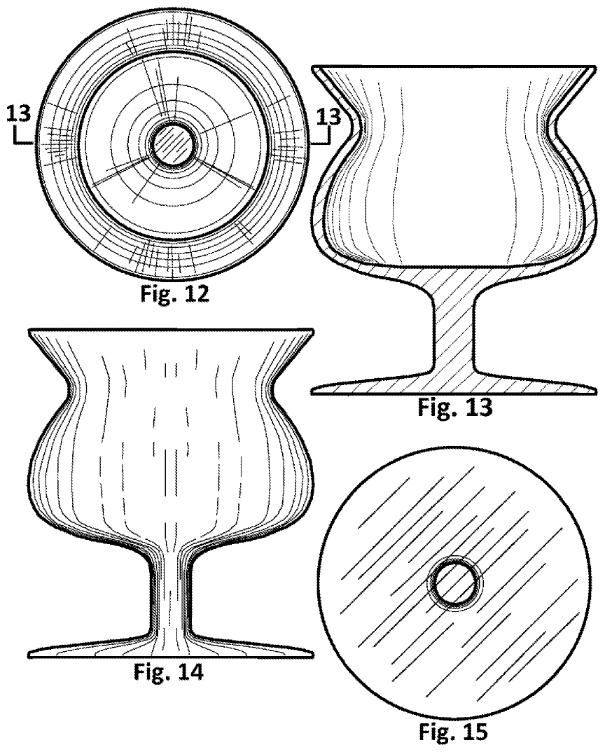

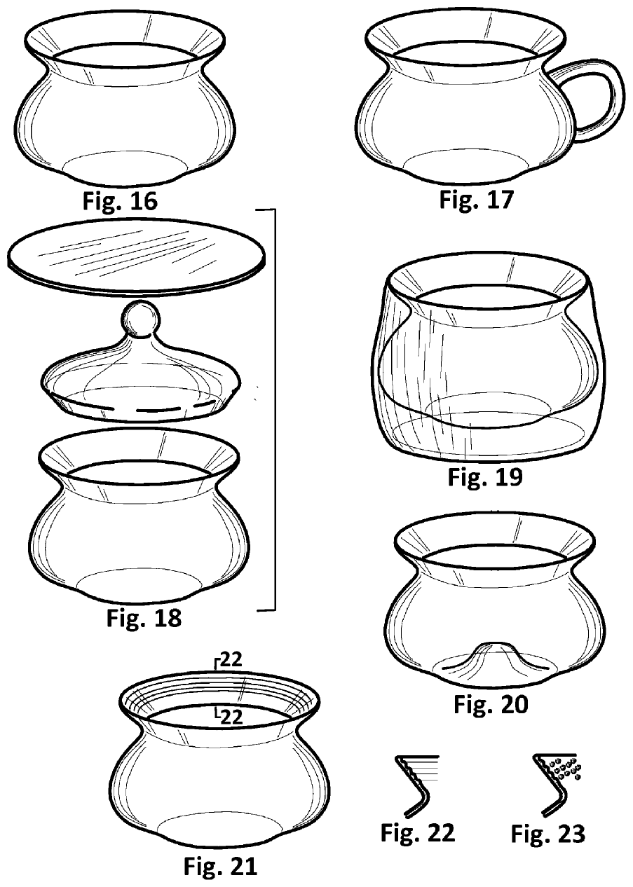

Manufacture and Materials of the Vessel—FIGS. 1-23

Methods of manufacture include hand-made mouth blowing methods, machine blow molding, machine pressing, casting, turned or lathe spun, ground, hand lamination, or nanotechnology from any material which is safe to use as a drinking vessel. Said materials include but are not limited to glass, crystal, woods, metals, resins, polymers, plastics, graphite fiber, nanotech materials, paper, mineral, rock or stone, clays, porcelains, kaolins, ceramics, concrete or aggregate in any color, texture, or appearance.

Detailed Description of the Procedure or Method

The procedure herein described, replaces the need for stop-gap procedures and preconditioning techniques which alter the beverage or attempt to precondition the olfactory organ to the presence of ethanol. Said application procedure promotes separation and dissipation of ethanol aroma prior to nosing.

The application procedure is comprised of at least the following: Step 1 in which a sample of alcohol beverage is poured into the bowl at evaporative surface plane 32; step 2 in which vessel is held in the palm of the hand to add hand heat to warm, and alternately held by neck 40 between thumb and forefinger to allow cooling, the combination of said alternate methods controlling liquid temperature and evaporation to the sampler's preferences; step 3 in which swirling increases evaporation and vapor pressure; step 4 in which odorants and aromas are collected in evaporation chamber 31; step 5 in which said odorants are concentrated by convergent sides 33, step 6 in which said odorants are forced by vapor pressure through orifice 34 into expansion chamber 35; step 7; in which lighter ethanol molecules expand outward and separate from remaining odorants and aromas prior to olfactory sampling; step 8, in which placement of human lips on rim lip 38 locates nose in proximity of sweet spot 39; step 9, tilting the head slightly forward or back to adjust nose position to seek proximity of most detectable aromas; and step 10, during transfer to the palate for liquid sampling, rim lip 38 delivers a wide sheet waterfall shape to expose more taste buds at contact and broaden flavor profile.

Detailed Description of the Process

The process described herein separates and diverts ethanol from other odorants and aromas by collecting, condensing, and concentrating said odorants and aromas utilizing orifice 34 to increase molecular collision frequency and velocities of lighter ethanol molecules forced through said orifice by vapor pressure, to escape during expansion, and separate from heavier aromatic odorants prior to olfactory sampling.

Advantages of the Vessel, Procedure or Method, and Process

Advantages of one or more aspects of the vessel, the procedure or method, and the process to individual tasters, nosers, samplers, aficionados, collectors, critics, and casual drinkers, are: dissipation of ethanol to provide an improved drinking experience without olfactory desensitization or strong disagreeable ethanol aroma; more detectable, definitive, pleasant, distinctive, discernible, and memorable olfactory and gustatory sample of aromas for tasting and sampling evaluation; more sensitive noses can appreciate drinking spirits without debilitating, neuropathological, disagreeably strong and overpowering ethanol; expanded markets to females, who as a populace generally have more sensitive noses than males; elimination of altering beverages by adding water or ice to reduce alcohol evaporation to make the spirit more approachable, which dilutes the spirit and closes down all evaporation and aroma characteristics; elimination of common altering of beverages by adding chilled stones, marbles or ceramics to reduce alcohol evaporation to make the spirit more approachable, which lowers beverage temperature and closes down evaporation and aroma characteristics; better agreement among judges at competitive awards events without strong ethanol to obscure and mask subtle aromas, a methodical process to maximize dissipation of ethanol and improve the odorant nosing and sampling process. The rim lip delivers a broad initial flavor profile to more taste buds for sampling and evaluation.

One or more aspects of the vessel, procedure and method, and process also provide several benefits to the alcohol beverage industry. Better manufacturing quality control during aging and cellaring by providing accurate, earlier detection of aromas which indicate poor quality; more accurate, advanced information for planning unique blends, additions, and concoctions for future marketing and sales; reduced blending times to reproduce or recreate a unique product edition by improving the blender's judgment without ethanol interference; expanded markets to sensitive noses and women, increasing sales and demand, driving prices and profit margins higher; improved uniformity of evaluation at competitive events, by unmasking subtle aromas for judges and evaluators; added niche and specialty markets for unique product editions with specific aromas; expanded collector markets by presenting and unmasking subtle complex aromas, leading to a better understanding of beverage characteristics. The procedure provides a uniform method for sampling alcohol beverages which improves correlation among samplers, nosers, tasters, judges, and critics within the beverage industry.

### DETAILED DESCRIPTION OF THE EMBODIMENTS

Several embodiments of the vessel have various appendages to improve handling, gripping, and holding, such as stem and foot (FIGS. 12-15), or cup handle (FIG. 17). Similar embodiments include addition of ears, a ladle handle, or a detachable apparatus to surround the vessel with a holding and handling appliance similar to a quaitch.

Other possible embodiments include double vessel walls for insulation (FIG. 19); an ornamental lid (FIG. 18), or an alternate watch glass cover (FIG. 18) to provide vessel closure for reaching evaporative equilibrium prior to nosing.

Other embodiments of the vessel have ridges (FIG. 21, 22), bumps (FIG. 23), grooves, troughs, dams, or cuts either on the inside of the vessel bowl to promote mixing with air while swirling, or on the inside of the divergent rim area to promote mixing with air while sipping, or a combination of both.

Other embodiments utilize surface treatment such as frost etching, ridges, thumb and finger placements to improve grip, or identification or personalization marks, initials, decorations, etching, appliques, decals, or grinding to individual preference.

Another embodiment utilizes geometry or shape changes to the vessel rim in order to ergonomically accommodate and fit the shape of the human lip more precisely.

Another embodiment has a rough ground or etched surface on the exterior to add and place identifying marks, letters or numerals to denote and identify a particular sample with a marker pen, pencil, crayon, or paint or other such instrument.

Conclusion, Ramification, Scope

In conclusion, at least one variation of the alcohol beverage and spirits nosing, tasting, drinking and sampling vessel; the procedure or method for using same; and the process to separate ethanol vapors from sampling odorant vapors prior to nosing provides a useful function to individual tasters and nosers, by dissipation of ethanol to improve tasting experience, and set a new level of appreciation for subtle aromatic intricacies of alcohol beverages. Dissipation of ethanol will attract more of the populace with sensitive noses to appreciate drinking spirits without neuropathological, disagreeable ethanol, and expand markets to more women. Dissipation of ethanol will avoid altering the beverage with water, ice, or chilling to reduce ethanol as unnecessary, and permit the beverage to be sampled, nosed, and tasted as produced without ethanol side effects. Dissipation of ethanol will diminish controversy and result in better agreement among judges at competitive awards events without strong ethanol to obscure and mask subtle aromas.

Benefits to the alcohol beverage industry, include improved manufacturing quality control during the aging and cellaring process from earlier detection of aromas which indicate poor quality; advanced information for planning unique blends for future marketing and sales; reduced blending times; expanded markets to sensitive noses and women; increased demand, sales and profit margins; improved evaluation uniformity; added niche markets; expanded collectors markets, leading to a better understanding of alcohol beverages, and providing a better correlation within the industry by standardizing procedures and vessel for nosing and tasting alcohol beverages.

The ramifications are; major changes to perception, marketing and sales of alcohol beverage industry products by increased awareness of aromatic subtleties of these beverages and changing the demand and markets for certain aromatic characteristics.

While the above specification contains multiple specificities, these should not be construed as limitations on the scope, but rather as an exemplification of several of the embodiments thereof. Many other variations of shape within the application are possible. For example, within the scope of the embodiments, many shapes can be tailored and fine-tuned to provide and showcase specific odorants and aromas, while accomplishing the claims of dissipation of ethanol alcohol. Many variations may be applied to the procedure or method of manipulating evaporative vapors. For example, the decision of best pour level and whether to add hand heat or use a cover to obtain evaporation equilibrium are the noser's choice, depending on his own olfactory sensitivity and desire to fine tune the odorant sample. Accordingly, the scope should be determined not by the embodiments illustrated or discussed, but by the appended claims and their legal equivalents.

The claimed apparatus is a nosing and tasting vessel, and the claimed method is for using the vessel in accordance with its advantages. Thus, the rim diameter is important, such that with lips placed on the rim, a user's nose can achieve a position in the proximity of the center of the rim plane when the head is tilted forward.

For a measurement from the lip to the end of the nose to use as the radius of the rim (1/2 the diameter), based on measurements from several individuals, averaged, the inventor's research based on actual measurements and charts from dentistry manuals and professional associations established to the inventor's satisfaction that the adult human maxillary central incisor overall length can reliably be taken to be approximately 23.5 mm. Adding 3-5 mm for the lip projection below the front incisor, and 4-7 mm for the distance from the root end in the skull to the lower end of the nasal opening in the skull, the inventor arrives at a supportable average of approximately 33 mm as a logical establishment of the dimension from the bottom of the upper lip to the base of the nasal opening in the maxillary bone of the skull. This dimension is used to approximate the minimum desired radius of the rim plane to accommodate positioning of the nose within the disclosed proximity near the central area of the rim plane.

These dimensions further support the projected dimension as the hypotenuse of a right triangle with its right angle apex at the base of the nostril opening in the skull, which extends from the lower edge of the upper lip to the outer edge of the nostril, and which would be the measurement one would use to begin construction of the device from the disclosed information. The shortest leg of the triangle, 23 mm is the average distance from the nasal passage entry through the maxillary skull bone to the outer edge of the nostril. By simple mathematical calculation of the hypotenuse of a right triangle, I arrived at a dimension of 40 mm as an upper limit for the vessel rim radius. It is therefore safe to say that the effective radius of the rim plane must lie between 33 mm and 40 mm, defining the diameter of the rim plane of said device to be within a range of 66-80 mm. This means that larger or smaller diameters will not allow the nose to be positioned in the proximity of the central axis and center of the rim plane of the device, and disputes any shape manipulation which could place the nose outside the range.

It is also stated in the disclosure that the effective height from the top of the rim to the surface of the liquid may be no greater than 1.7″ (45 mm) and that the liquid surface is at the maximum bowl diameter, leading to a maximum bowl diameter plane location at no more than 45 mm below the rim plane surface. These dimensions dictate that the neck of the vessel must fit within a space of 45 mm, associated with a rim plane diameter of approximately 80 mm (40 mm radius×2 to get diameter). Larger diameters will move the nose away from central proximity. With reference to previous art, the general shapes of Rosow D495210 and Venon D74401 cannot possibly simultaneously satisfy the above established diameter range and the distance to the rim from the liquid evaporative surface.

As an expert in the art, and the founder of the art, the inventor immediately recognized the importance of rim angle. The disclosure states that the rim angle must be sufficient to allow an adequate escape for the ethanol; therefore rim angles of less than 45 degrees from the vertical axis would tend to promote remixing of the neck separated ethanol molecules with the other character aromas, defeating the purpose of separation. The inventor recognized that rim angles greater than 45 degrees from vertical would tend to approximate a single edge, as the ramp would become less significant in directing the escape of the ethanol. The inventor determined the best angle of the rim for a given liquid of known percentage alcohol by volume, understanding that straying too far in either direction from the logical 45 degrees mean ramp angle would be detrimental. Increasing the angle to greater than 45 degrees from the vertical axis will immediately increase the opportunity of spill, and makes the vessel nearly ergonomically impossible to drink from. Therefore, logic dictates that the angle should never be greater than 45 degrees from the vertical axis to facilitate the limits of human ergonomic function. The inventor considered these factors with careful contemplation and forethought in designing the claimed invention.

As can be seen, rim angle is important to the stability of the vessel, the user's ability to drink from it, and the vessel's effectiveness at dissipating ethanol while making other vapors accessible in the proximity of the center of the rim plane. Considering the physics of evaporation when passing mixed vapors through a restricted orifice, the inventor determined that what has not been done before, to our knowledge, is to separate molecules of lighter mass and simpler shapes from those of higher mass and more complex molecular shape (those having longer chains, for example) in a nosing and tasting vessel. In fact, the very reason that convergent rims have endured for centuries is due to the fact that no one challenged the premise that ethanol molecules could be separated from other molecules with even a remote degree of success. Evaporative partial vapor pressures of different compounds make up the total evaporative pressure of a given mixture (such as a whiskey or aromatic spirit). Forcing this mix of evaporated molecules through a restriction increases the probability of molecular collisions and reduces the spatial volume and distances between molecules. As the different molecules are pushed together, the incidence of collision between them is increased.

Applying Newton's Third Law, we note that in a collision between two objects, both objects experience forces that are equal in magnitude and opposite in direction, resulting in an exchange of momentum. Momentum being conserved, as the law states, a collision of a lower mass molecule with a higher mass molecule results in the lower mass molecule having generally higher velocity than that of the higher mass molecule. Thus, as the vapor pressure of the liquid continues to force the vapors through the restriction, the expansion on the atmospheric side of the restriction allows the faster, lower mass molecules (in this case ethanol) to “run away” from the mixture, thus quickly separating the lower mass molecules from the higher mass molecules. The higher mass molecules linger. They can be detected, sensed and appreciated by a person whose nose is positioned where they are lingering in the proximity of the center of the rim plane without the presence (and therefore human nasal detection) of the lighter molecules.

The design patent references, Rosow and Venon, do not simultaneously meet the following two limitations: positioning the nose as stated; not exceeding the stated maximum vertical distance from maximum diameter portion to rim plane.

It should be appreciated that the multiple features of the claimed structure cooperate to produce an effect which (1) was never expected in the entire history of the art of beverage nosing and tasting glassware, (2) provides beverage drinkers, experts, and aficionados the ease of use, the enhanced experience of scent with reduction of alcohol burn, and the overall nosing and tasting enjoyment that has led to the success of the commercial embodiment, and (3) provides the reduction of fatigue that contributes to the strong preference for the commercial embodiment exhibited by professional tasters and contest judges.

A Long-Felt But Unresolved Need exists for, and Others have failed to establish, an Alcohol Beverage and Spirits Nosing, Tasting, Drinking, and Sampling Vessel, and a Procedure or Method for Using Same, and a Process to Separate Ethanol Vapors from Sampling Vapors Prior to Nosing.

Three basic areas define a long-felt need for uniformity in evaluating alcohol beverages; (1) evaluation methods, (2) rating system and attributes-weighting, and (3) glassware design and function. Over time, advances in each separate area have steered the evolutionary focus to one of the other “weaker” areas to reach the current state of the art. Therefore, to have a complete understanding of the long-felt need for something like the instant invention and the long-standing failure to develop such, it is important to note the totality of these advances and how they have collectively affected the state of the art. The following time-line summary is an extreme condensation of the evolution, and highlights only the major efforts to establish uniformity in alcohol beverage evaluation methods and glassware design and function by major manufacturers, attempts to set evaluation standards and the effects of notable experts.

1673: George Ravenscroft invents leaded crystal. Adding lead oxide (PbO, 10-30%) to recreate the visual experience of Venetian cristallo, Ravenscroft patented his formula and produced glassware with two side benefits: (1) sea coal, cheaper and readily available in England, could be used to melt the softer glass, and (2) lower working temperatures extended the working time of the glass, allowing production of more intricate shapes and decorations and beginning the quest for more unique shapes. This development had the notable, but unintended, side effect of changing the aromas and visual presentation of alcohol beverages. This change, in turn, gave birth to a movement toward making convergent rim vessels for the purpose of concentrating all aromas at the nose (under the widely accepted premise that they could all be detected if none were allowed to escape), making somewhat larger bowl volumes to dilute the alcohol aroma with more air, and adding stems to raise the vessels and catch more light, enhancing visual evaluation in a world of exclusively candlelit dining. Thus we mark the beginning of modern experimentation with glassware shape and exploration of the relationships between vessel shape and aroma.

1893: Otto Schott invents borosilicate glass. More durable glass resulted in thinner wall thickness, thinner (and longer) stems, and a larger foot (allowing even longer stems and wider bowls to take advantage of the greater support, further exploring large bowl, convergent rim design). Much larger bowl volumes can be manufactured with borosilicate (tradename Duran), again changing the aroma profile of alcohol beverages, and inspiring the large bowl thin-wall brandy snifter for nosing high alcohol spirits.

1958: Riedel of Austria creates the first varietal specific glass. The Burgundy Gran Cm model begins the proliferation of different shapes of glasses for different varieties of grape which are characterized by different aromas, and utilizing different shape glassware to present the unique and specific aroma characteristics of each varietal. The Riedel Wine Glass Company, an example of a multinational concern dominant in the industry, now produces well over 40 varietal shapes, with specific aromas attributed to each, and the number is still rising as of this writing, in spite of rejection by the sensory scientific community. As to this perfusion of shapes, however, it should be noted that in 1974, Virginia Collings, a researcher at University of Pittsburgh refuted the tongue map (long accepted reference on taste Edwin G. Boring, D. P. Hanig 1901) the basic science which supported Riedel research, and again rejection reinforced by Linda Bartoshuk, University of Florida in an article in Gourmet magazine, which exposed Riedel's mistaken dependence as “invalid and unscientific.”

1973: Riedel establishes the Glass Workshop. This program began an extensive collaboration with sommeliers, wine and spirits makers, and alcohol beverage critics of note, for the specific purposes of developing glassware for wine and spirits to present the best aromas and establish specific tasting and evaluation procedures and methods.

1976: Judgment of Paris. Alcohol beverage evaluation and judging was ignored by the general public until 1976 when Steve Spurrier, a British wine merchant, organized a blind (origin and labels concealed) tasting of French versus American made wines. American wines had been deemed inferior by the European wine community largely because Americans lacked the Europeans' centuries of wine making experience. The Judgment of Paris tasting by sommeliers and experts in wine making, awarded top honors in white and red wines to American made wines, launching international demand for the American wine industry, and causing the experts of the world to re-examine the controversial subject of how wines are evaluated and rated, and what should be the preferred method of evaluation. All wines were graded on a 20 point scale.

1977: ISO Standard 3591 is published. Further evidence of a long-felt need emerged in the form of the International Standards Organization (ISO) specification for a wine glass design and evaluation method. These standard become the accepted standard for wines (for about a decade or so) and were almost immediately adopted by the spirits industry with certain modifications to alleviate the strong alcohol nose burn. While they are still in use today, they rapidly are being replaced by the vessel and method of the instant invention, which alleviates the alcohol concentration and nose burn. The Applicants herein are currently in the process of submitting to the ISO a new proposal for apparatus and method of evaluating spirits.

In the 20^{th} Century, acceptance of glassware in conformity with the ISO standard replaced glassware by the spirits industry had replaced the standard sherry copita, which originally came to the UK as England expanded trade routes and began importing sherry and port wines in the 1500s. In a search for cheap barrels to mature scotch whisky, the distillers discovered stockpiles of sherry barrels left over from rebottling in UK, and simultaneously adopted the traditional sherry glass used by the English sherry consumer, or copita, since it worked well for fortified sherry of higher alcohol content (around 22% ABV), and was smaller to prevent waste of a more expensive whisky distillation. The ISO glass is very similar in shape and size, and adopting the ISO official standard gave some import, perceived validity and credibility to adhering to a standard already approved by a well-known regulatory body, even though the ISO was designed with lower ABV wine evaluation as its purpose.

1978: Beginning of the golden age of alcohol beverage critics (experts). Publication of The Wine Advocate, by lawyer-turned-oenophile Robert M. Parker, comes to the forefront as an opinion leader, and most experts quickly adopt European wine glasses of the Riedel design, much larger than the smaller glass defined by the ISO standard. Photographs, books, news articles, personal appearances, public tasting events, and social media exposure fixes public preference to the larger bowl, long stem glasses. Robert Parker created the 100 point evaluation scale, and became the most important critic in wine, publishing and teaching wine evaluation methods, rating and weighting systems. He became the revered critic and guru of the public, as wine producers notably live and die commercially on his pronouncements and ratings, and adopt his preferred tasting methods, very similar to those set forth in the ISO standard. The proliferation of magazines, competition events, “how-to” instructions, movies, television programs, books and research publications concerning aromas and GCMS studies of spirits demonstrate the long-felt need of the public to understand alcohol beverages, and from this grows the need and added impetus to the search to remove variables in methods and apparati to provide a consistent and standard evaluation baseline.

1990: Michael Jackson emerges as most noted critic (expert) of spirits. Experts emerge to fill the void in the spirits arena, and Michael Jackson, English writer and journalist, parallels Robert Parker by becoming the most followed expert of beers and spirits. The 100 point evaluation scale designed by Robert Parker, is quickly adopted by the spirits industry because it allows more room for precise evaluation than the long accepted 20 point scale. Michael Jackson establishes popularity of the ISO wine glass as the preferred spirits glass, noting that wine glasses are too large for proper evaluation, and result in proliferate alcohol on the nose leading to olfactory fatigue. He, as well as many others, become leaders in establishing accepted tasting methods and procedures designed to keep the ISO nosing glass as the preferred glassware for spirits (in spite of its propensity to concentrate alcohol aromas), which devices are adopted to attempt to alleviate alcohol nose burn. These devices are; (1) adding water to slow the evaporation of alcohol, (2) wafting the aromas toward the nose to acclimate to the presence of strong alcohol, (3) refraining from swirling, (4) breathing with mouth open to lessen the burning effect of strong alcohol on the nose. Although Michael Jackson died in 2007 of Parkinson's Disease, his publications on Bourbon and Irish Whiskey, Scotch Whisky and Beer are still considered basic primers for tasters and evaluators, and as stated, his legacy method at best employs various procedures to use and protect the inadequate ISO glass originally designed as a wine tasting tool, as his preferred standard for spirits tasting and evaluation. His reputation as an informed notable and educational leader in spirits evaluation vaulted his ratings of spirits to at least the commercial importance of the wine counterpart, Robert Parker, and has firmly entrenched him as an irrefutable source of information on spirits (particularly scotch whisky.

1996: Aime Dubois submits utility patent for a Snifter for alcoholoic beverages such as brandy, spirits, and liquors (Invention lapsed 2013-o2-20 for failure to pay maintenance fee, U.S. Pat. No. 6,189,715B1) This invention was designed to lessen the effect of alcohol on the nose by limiting the evaporation surface area at the prescribed fill level or by adding water or ice to reduce evaporation to provide a glass for tasting alcohols that allows a full olfactory appreciation, with less alcohol aroma on the nose. However, the preferred suggested sampling method is through a straw, to avoid orthonasal nose numbing alcohol aromas, in an attempt to fulfill the long-felt need, and the aromas are severely diluted by water, ice, or the severely reduced evaporation surface area at recommended fill, rendering them largely weak and somewhat more undectable with retronasal sampling, these shortcomings, being overcome by the vessel and method of the instant invention.

2011: Sir Adam Carmer publishes the CSTEM method of spirits evaluation. In his UNLV University Library publication, doctoral thesis paper 1048, completely ignoring glassware design and function, Sir Adam Carmer proposes a method of tasting which eliminates the orthonasal smelling and evaluation of spirits to avoid alcohol nose burn, restricting olfactory sampling to retronasal (pharyngeal opening) passages only. Although initially considered by many leading critics, it has been subsequently rejected as being outside the comfort zone of most, who depend on orthonasal aromas as the first sign of safety in drinking or eating (“if it smells ok, I can safely drink it”). Carmer's paper cites a proliferation of references as to more detailed evaluation methods and techniques which embody a more detailed history of the long-felt need for a standard spirits tasting method, and which, if accessed, quickly expands the case in point.

2011: Introduction of the apparatus and method of the instant invention. In this year, Applicants filed a provisional application for patent for the above named apparatus, method, and procedure alleviates the alcohol nose burn and establishes an apparatus, a method, and a procedure which overcomes problems associated with current apparatus and methods, and meets the long-felt need as described.

There is evidence of Commercial Success for an Alcohol Beverage and Spirits Nosing, Tasting, Drinking, and Sampling Vessel, and a Procedure or Method for Using Same, and a Process to Separate Ethanol Vapors from Sampling Vapors Prior to Nosing.

Case 1: The following Events and Competitions use the apparatus and tasting method of the instant invention as their official spirits evaluation and judging glass. Judges are typically experts in the industry, the vast majority of whom are professional sommeliers, mixologists, distillers, vintners, and alcohol beverage industry and distribution executives, as well as noted critics/authors experienced within the scope of the industry. More competitions are being added every year as popularity of the glass becomes known. No event has ever used the glass and then decided not to use it in following years, attesting to the validity and industry acceptance of the vessel and method of the instant invention.

2013-2016 San Francisco World Spirits Competition (largest competition in North America)

2013-2016 New York World Spirits Competition

2013-2016 San Diego Spirits Festival

2013-2016 Miami Rum Renaissance Festival and Consumer Rum Jury Competition

2014-2016 Los Angeles Craft Spirits Competition

2014-2016 Wine and Spirits Wholesaler Association

2014-2016 SIP Awards (world's largest consumer judged spirits awards competition)

2015-2016 Irish Whiskey Awards, Dublin Ireland

2015-2016 California Rum Fest

2016 Denver International Spirits Competition

2016 North American Bourbon and Whiskey Competition

2016 Nightclub and Bar Show Spirits Competition

Case 2: Magazine Awards: The following publications have bestowed awards on the commercial embodiment of the present invention.
2011 Vegas Seven Magazine: Most useful bar tool award
2013 Beverage Industry News: Editor's Pick Award of Excellence

Case 3: Distributors are licensed and selling in UK, Taiwan, Australia and New Zealand, and Canada, and all, including manufacturers have signed Non-Disclosure Agreements. Additional licensing is currently being sought in Germany, France, and Japan. The apparatus is manufactured in USA in Millville, N.J. by Arc International, in Slovakia by Rona AG, and hand blown versions are manufactured in Peoples Republic of China, imported through Built-In-China, of California. All have signed non-disclosure agreements.

Case 4: Design patent D663165, Utility Patent Peoples Republic of China O/R: PT-FPAP-140037-SBY, and pending utility patents in USPTO and WIPO.

Case 5: Total sales as of EOY 2015 approximately 6,000 UK, with production orders pending for 8,000 (in 2016), Taiwan approximately 4,000, Australia and New Zealand 4,000, USA, approximately 130,000.

Case 6: Major catalogs, Touch of Modern, Houz, Wine Enthusiast, Wine Stuff, The Gift Place, Alrossa, NeutraGroup. Major chain liquor stores, Specs (160 locations) and Total Wine (130 locations)

Case 7: Most major alcohol beverage glassware left the country for Europe in the first decade of the century as two major corporations cornered the market, putting small producers out of the glassware business by purchasing their drinking glass making facilities in return for compensation and non-compete agreements. Production technology and emphasis on quality made Europe the preferred manufacturer worldwide for spirits and wine glassware, where the image and functionality were more important to the aficionado wine and spirits drinkers and fine-diners, leaving the USA manufactured product to stemless every-day usage tableware, water and soda glasses with a clunky appearance, lower scrap rates (higher acceptability of defects), poorer quality, and lower price to accommodate a single purpose as a vessel to hold and transport one's drink from container to mouth. Imported spirits glasses have higher costs with higher scrap rates (lower acceptability of defects), better glass formulation (borosilicate vs sodalime, better durability, stems if desired, and are purchased by those who still perceive a quality value in the added cost. USA now has one manufacturer of specific, functional alcohol beverage glassware, the licensees of the rights to produce the subject glassware.

Case 8: Further evidence of commercial success: The largest coffee company in the USA and a smaller craft coffee company currently use the subject vessel for blending commercially produced coffees due to its aroma handling capability. A major essential oil manufacturer uses the vessel to sample his essences during the process to ensure he is making an acceptable batch prior to its final reduction (longer processing time) to reduce waste. This company is also sharing the process with a perfume maker and a spirits infusion manufacturer. A notable and respected Japanese (Urasenke school, name So-en) tea teacher from California uses the glass to discover the subtle aromas in rare teas. A California olive oil manufacturer uses the glass to showcase aromas to prospective buyers and customers.

The qualifications of Inventor George F. Manska should be noted.

Wine: Since 2002, the inventor has been an active member of the prestigious international Commanderie de Bordeaux, having traveled extensively to the Bordeaux region of France, barrel tasting and blind tasting annual cuvees of top five growth classifications, rendering purchase decisions for the local chapters. During that time, the inventor has been a member of the International Board of Governors and the Maitre and founding member of the Las Vegas Chapter of the Commanderie de Bordeaux. I have toured most California appelations, as well as those of Alsace, Euskadia, and Spain, tasting with prestigious vintners in private product tastings. Spirits: the inventor has actively participated in annual spirits competitions as an advisor and consultant regarding the nosing process since 2012. The inventor has been the competition event coordinator for the San Diego spirits Competition for the last three years and will continue that position in 2016. The inventor also is a nosing and evaluation consultant to the Rum XP Jury of the Miami Rum Festival, the Irish Whiskey Awards, the San Francisco and New York World Spirits Competitions, the Spirits International Prestige (SIP) Awards, and the California Rum Festival.

Publications: The inventor has written and published three white papers on the process of nosing and evaluating spirits, as well as consulting on timely articles regarding judging and evaluation of spirits in Tasting Panel Magazine, Artisan Spirit Magazine, and am currently developing a curriculum of study for the Artisan Craft Distilling Institute. In addition, the inventor developed and submitted seminar proposals for 2016 to the American Distilling Institute, American Craft Distiller's Association, and the Wine and Spirits Wholesalers of America, Inc., professional organizations within the spirits industry. The inventor prepared a proposal for a spirits evaluation method to the International Standards Organization for adoption. The inventor is a member of American Distillers Institute, American Craft Spirits Association, and the United States Bartenders Guild, making frequent appearances to explain tasting procedures to the membership. The inventor has worked with members of the Consejo Regulador del Tequila and Consejo Regulador del Mezcal to finalize proposals to adopt a standard tasting procedure and method.

A: Anthony Dias Blue

Mr. Anthony Dias Blue is Executive Director and founder of The 2015 San Francisco World Spirits Competition and Founder and Editor in chief of Tasting Panel Magazine June 2015. Anthony Dias Blue is recognized worldwide as a leading food, wine, spirits and travel expert. Along with being a published author, columnist, TV and radio personality, Mr. Blue also heads a food & wine events company and hosts food & wine competitions worldwide. His award-winning work spans all forms of media and is circulated to more than 30,000,000 consumers each month. RadioBlue has a long-running feature spot on WCBS radio in New York City featuring restaurant reviews and lifestyle subjects, mostly associated with food and wine. Now called The Blue Lifestyle Minute, the feature has been on every day for more than 30 years (except for the two weeks following 9/11). Blue received a James Beard Award for the Minute in 2001. A separate, localized version of The Blue Lifestyle Minute began airing in 1999 on KFWB in Los Angeles. In 2009, this feature moved to KABC along with the addition of a new weekend show called The Taste Buds co-hosted with Meridith May and Merrill Schindler. In 2014 Blue left KABC and moved The Blue Lifestyle Minute to KNX (AM) 1070. This brings Blue's listenership to over 200,000. Publications. In 1978, Blue became West Coast Editor of Food & Wine magazine and then later in 1980 he became Wine and Spirits Editor of Bon Appetit Magazine, a position he held for 26 years. Anthony also wrote a weekly syndicated wine column that appeared in the Bay Area, first in the San Francisco Chronicle and then in the San Jose Mercury News. For 10 years, Blue wrote and edited the Zagat Guide for northern California for his friend Tim Zagat, with whom he attended Riverdale. After leaving Bon Appetit in 2007, Blue purchased in partnership with Publisher Meridith May Patterson's Beverage Journal, a 65-year-old beverage trade publication that was renamed The Tasting Panel. It has become the highest circulated beverage industry publication. In December 2013, The Tasting Panel magazine acquired The Sommelier Journal with Blue as the new Editor-in-Chief along with a team of top wine and hospitality industry writers. In 2015 Blue and May announced a new quarterly magazine to begin publication in 2016. Called THE CLEVER ROOT the new publication will focus on agricultural subjects, particularly cannabis. Competitions. Blue runs the San Francisco International Wine Competition, the largest international wine competition in the US. In 2000 Blue launched the San Francisco World Spirits Competition which has become the largest spirits competition in the United States and second largest spirits competition in the world.

Concerning Results of the 2015 San Francisco World Spirits Competition, Mr. Blue has stated, “After considerable comparative tasting conducted by myself, Chief Judge Tony Abou-Ganim and others, it was decided that the unique properties of the patented NEAT Glass make it the best vessel from which to assess the characteristics of a spirit. Because of its exceptional shape, this glass eliminates the strong alcohol burn present in most other spirits glasses that can seriously interfere with rendering a well-considered judgement.”

Mr. Blue further stated, quoting Tony Abou-Ganim, Chief Judge, The 2015 San Francisco World Spirits Competition: “‘It is perfectly designed,’ Tony Abou-Ganim said, ‘The NEAT Glass is able to capture the essence of every spirit.’ Most judges found, because of not having to deal with the alcohol burn typical of other glasses, that the entire tasting experience was less fatiguing than in the past. The glass also made for more accurate judgements.”

On the Applicants' information and belief, the quoted Mr. Abou-Ganim is author of The Modern Mixologist: Contemporary Classic Cocktails (Agate 2010), DVD; is author of Modern Mixology: Making Great Cocktails at Home, Vodka Distilled (Agate 2013) is a blogger and the owner of the website www.modermixologist.com; is the winner of three Iron Chef America competitions, pairing cocktails with Chefs Mario Batali, Jose Garces, and Sean McClain; is founder of the signature branded line of Modern Mixologist bar tools; is host of the Fine Living television program Raising the Bar: America's Best Bar Chefs; and is a renowned spirits reviewer.

The citation for Mr. Blue's statements is https://static1.squarespace.com/static/54d1abeee4b09fd8a1758b19/t/55885b36e4042906e152b2 f/1434999606137/518118-June+2015_sekected-pages.pdf.

B. Isaac LaFond

In a review published Mar. 9, 2015, Mr. Isaac LaFond states, “We poured 1.5 ounces of Booker's in both glasses and let it open up for about 20 minutes. Day and Night. The two experiences were completely different. I was astounded how much it lightened up Booker's. It was startling how easy it was to get the aromas from the NEAT glass and there was zero impact from heavy handed ethanol vapors that cause nose burn and fatigue. While I was able to locate the same aromas in each glass it was much less effort in the NEAT glass.”

The reference for Mr. LaFond's remarks is http://www.stogiesontherocks.com/article/neat-glass/.

C: The Scotch Noob Web Log

In 2012, The Scotch Noob Web log stated, “To test out these claims, I gathered a Glencairn glass, a rocks glass (as control), and a NEAT glass. I filled each with an equal amount (about ½ ounce) of Ardbeg Corryvreckan. I wanted a powerful, peaty dram to provide lots of fodder for nosing. I also wanted something cask-strength (57.1% ABV) to test NEAT's claims of lessening the nose tickle. I then allowed the drams to sit for a few minutes to rest. Now, the nosing:

“Rocks Glass: Holding my nose directly over the lip of the glass, I smell . . . a vague hint of peat, a little campfire smoke, and barely any burn. I hold my nose as deep as I can inside the glass (about an inch from the liquid's surface), and finally there's some citrus notes and enough alcohol burn to make me back away. As expected, the glass delivers barely any individually discernible notes.

Glencairn: Holding my nose directly over the lip of the glass, I smell some nice oaky vanilla, round earthy peat, and no nose tickle at all. Tilting the glass and holding my nose about an inch from the liquid, I get a tidal wave of citrusy peat, soft maltiness, big caramel and vanilla, and enough alcohol in my sinuses to make me cough.

“NEAT Glass: Holding my nose directly over the lip of the glass, I smell a hint of vanilla. No alcohol burn, but not even any peat. Tilting the glass and holding my nose about an inch from the liquid, I get . . . now this is interesting. There's no alcohol burn at all. Instead, I get totally unexpected (although faint) notes of tangerine, mushroomy peat, rosewater, and lavender. It seems that the “sweet spot” is a little difficult to find. If I hold my nose ABOVE the glass, I get nothing. If I hold it just inside the rim, I get some faint aromas only. If I stick it in as far as I can (which requires holding my neck at an awkward angle), I get a series of very clear aromas without the usual muddled rush of alcohol and top-notes. It takes a little experimentation to find the right spot.

“Conclusion: I'm actually a little confused. The rocks glass, as expected, is worthless. The Glencairn delivers the experience to which I have become accustomed: all of the aromas, big and bold, and a big plug of alcohol vapor right up my nose. It's easy to get a snoot-full of alcohol burn, but you also get a lot of aromatic compounds in one big integrated jumble. The NEAT glass requires pinpointing the ‘sweet spot’ (which wasn't where I expected to find it), and then does a surprising job of delivering toned-down but clear and crisp aromas to the nose without the distracting (or amplifying?) waft of alcohol vapor. The experience is actually a little unsettling: I smell vanilla, I smell peat, and I smell citrus, but I don't smell Corryvreckan.

“That brings me to my conclusion about nosing with the NEAT glass: it performs as advertised, but I wouldn't recommend it in isolation. To truly get the full effect of any dram, you should use a NEAT glass to pick out individual notes . . . and then use a Glencairn to get the full experience, alcohol and all. That said, if you have a sensitive nose and have trouble getting past the alcohol vapor's effect, the NEAT glass is tailor-made for you. Get a few of them NOW.

“One bonus with the NEAT glass: its wide rim (which takes a little getting used to) does actually spill the whisky evenly over your tongue, thus hitting all parts of the palate at once, rather than channeling all of the liquid to the center of the tongue, where it doesn't taste like much except alcohol. In this way, it performs better than the Glencairn. Also, note that the letters ‘NEAT’ are etched into the side of the glass. The company is working on a new version with a stem, as well.”

The reference for the Scotch Noob statements is http://scotchnoob.com/2012/04/02/review-the-neat-glass/.

D. S.D. Peters

In 2013, author S. D. Peters, a Washington, D.C. area taster and blogger specializing in whiskey, stated, “The NEAT Glass does have a slight learning curve. Placement of the nostrils is very important: precision is the order of the day. As I found, it's very easy to detect only the vaguest aroma without experiencing anything more complex if the nose is held a millimeter too high or a hair off from the mouth's center. And when sipping from the Glass, a very wide sip works best; otherwise, the whiskey escapes over the rim and down the side (of the glass and your mouth). The benefit of a wide sip, however, is a fuller coating of the mouth when the whiskey arrives, allowing it penetrate your taste buds without much work on your part.

“As my choice of samples makes apparent, I tested mostly mellow whiskeys. I was curious if the NEAT Glass would reveal anything more complex. It did not, but that's only to my nose. The potential that, for another nose, the undeniable dissipation of alcohol might yield a richer tasting, is worth noting. And the immediate benefit of noting aroma instead of astringency gives the NEAT Glass an edge, regardless of whether or not the tasting experience is richer.”

The citation for Mr. Peters' remarks is http://whiskeyreviewer.com/2013/07/upgrading-to-the-neat-glass_071913/.

E. Reviewer Ray Pearson

In 2012, Worldwide Delicacies reviewer Ray Pearson, who has several decades experience tasting whiskeys, and who is a whiskey reviewer, spirits educator, judge, and brand ambassador, stated, “This glass really works! In nearly 20 years as a single malt Scotch educator, many of them working for very well-known brands, I now realize I've never really smelled what the tasting notes (and company-speak) described. I mean REALLY SMELLED THE LIQUID. Now, there is a focus—rather than “spicy”, I now smell nutmeg; rather than “floral”, I now smell lavender; rather than “sweet”, I now smell caramel, and rather than “peaty”, I now smell a wet, earthy bog. Fantastic! The NEAT glass does for my olfactory senses what cataract surgery did for my vision—opened a whole new world.”

The citation for Mr. Pearson's remarks is http://www.worldwidedelticacies.com/2012/02/the-neat-glass/.

F. Reviewer Stefanie Payne

In 2012, Worldwide Delicacies reviewer Stefanie Payne, Independent food and spirits reviewer contributing reviews to CityRoom LLC, stated, “What really struck me was how different characteristics took front stage depending on where I held the glass in reference to my nose. Out of the left nostril at the top of the rim . . . maple? And the right nostril at the base of the rim . . . oak . . . and everywhere, the obvious scent of alcohol (ethanol) was subdued completely, letting the components themselves shine . . . And low and behold, a subtle hint of orange peel. YUM!” The citation for Ms. Payne's remarks is http://www.worldwidedelicacies.com/2012/02/the-neat-glass/.

G. Scotch Blog

A 2012 Scotch Blog article stated, “Right off the hop and for each and every whisky, the NEAT glass certainly delivered on its first promise. Head-to-head against the Glencairn it delivers a demonstrably diminished alcohol element. Gone is the blast of ethanol that singes nose hairs and sinuses, instead providing only the scents and sensations of the malt, spirit, and wood. For those who have issue getting past the alcohol vapours in a nosing, yet love their whisky, there is no question that the NEAT glass is the next item they should purchase. —See more at: http://www.scotchblog.ca/scotch_blog/2012/04/game-on-in-glassware-glencairn-vs-the-neat-glass.html#sthash.Ole1v6N3.dpuf”

A citation for these remarks is http://www.scotchblog.ca/scotch_blog/2012/04/game-on-in-glassware-glencairn-vs-the-neat-glass.html.

H. Chris Carlsson

Spirits Review article author Chris Carlsson stated in 2013, “Testing: Really does remove the alcohol vapors quite a bit when nosing and tasting, allowing you to concentrate on all the other aspects of a particular spirit and lets you enjoy and or evaluate all the other facets without the alcohol overlaying or interfering with your nosing—quite remarkable!”

The citation for Mr. Carlsson's remarks is http://spiritsreview.com/reviews/the-neat-glass/.

I. Paul Hashemi

SIP Awards/International Consumer Tasting author and Spirits International Prestige (SIP) Awards annual spirits competition founder Paul Hashemi stated in 2015, “This year NEAT is again the SIP Awards official judging and tasting glass. NEAT is far above all other glassware because it displays the spirits true aromas so everyone can accurately judge quality without formal evaluation training. NEAT's slogan is ‘Taste the Truth’. Science has produced a winner.”

Mr. Hashemi made the above statement publicly in the opening ceremony of the 2015 SIP (Spirits International Prestige) Awards to the audience of 100 spirits judges, and approximately 20 attending staff at the Balboa Bay Resort in Newport Beach Calif., on May 31, 2015. Remarks of Mr. Hashemi are traceable to http://sipawards.com/.

J. Whisky Belfast—Stuart Irvine

Whisky Belfast article author and blogger, whisky enthusiast and collector Stuart Irvine in 2014 stated, “VERDICT—With this particular whisky the “NEAT” glass is an absolute triumph. To allow you access the whisky in so much detail but then bringing out the fresher notes towards the end goes against anything I was expecting. All the flavours on show in the Glencairn were here in the “NEAT” glass in abundance but without any sting on the nostrils. Fantastic stuff”

The citation for Mr. Irvine's remarks is http://whiskybelfast.blogspot.com/2014/11/the-neat-glass-new-era-in-drinking.html.

K. Four Barrels Blog

In 2014, The Four Barrels Blog, which was created to review, share, and explore all things bourbon and bourbon related, stated, “The two bourbons that were chosen for our review was Angles Envy Rye and the Four Roses OBSV. Both spirits contain a great deal of flavor and amazing fruity notes from simply just removing the cork. Once we started using the neat glass, per their instructions, it was like using a magical key that unlocked a door of hidden aromas we had never experienced before in the whiskey. While sipping, we noticed that the bourbons aromas were more inviting and distinct. Each ingredient was distinguished from one another. I would like to make note here that before we used the Neat glass, we read their instructions on how to properly use it. This is a big deal. They want the user to understand and learn how to fully utilize the glass and get the most fulfillment from their spirit. On that note, their information and scientific process would make most peoples head spin, but without it I don't think they would arrive to where they are now. If you have time and want to learn a great deal of the science behind the neat glass, see their Nosing Science page on their webpage.”

The citation for these comments is http://thefourbarrels.blogspot.com/2014/02/experience-neat-review-of-the-ultimate.html.

L. Rum Collective, Nicholas Feris

Rum Collective article author Nicholas Feris, whoseNick's passion for rum began long ago maturing from a collector and blogger into an avid lifestyle, started Seattle's first rum society, The Rum Collective in 2010 and now hosts dozens of regular educational tastings and events at cocktail bars in the Seattle area each year. Nick is a judge at rum competitions, both national and internationally, most recently the 2012 Caribbean Rum & Beer Festival in Grenada. Additionally, he instructs regular tastings at Legacy Liquor, a premium retail location, in Vancouver, BC, Canada. On his website, The Rum Collective, he provides all of the photo-journalistic coverage of his meetings, local rum related topics as well as tours of rum distilleries throughout the World. Nick's articles have been mentioned on award winning sites and by magazines such as Forbes. In 2011, he formed, Rum Spoken Here, LLC, a consulting business to further spread the gospel of rum. In 2012, he was nominated for blogger of the year in 2012 by the Golden Rum Barrel Awards. Nick enjoys spreading the gospel of rum.

Mr. Ferris stated in 2013, “To clarify, I am referring to a glass that enhances your ability, or rather improves perception of the spirit's aromas upon nosing it. Recognizing the aromas rising from your glass is key and will often give you an indication as to the spirit's complexity and flavors to look for once in your mouth. It doesn't hold the visual appeal of a classical snifter (actually it first reminded me of a candle holder), but this glass does have numerous advantages. Here are just a few: First, let's get technical. The NEAT glass's curvaceous design has been shown to allow for the slower moving aromatic molecules in the vapor to concentrate in the center of the opening while at the same time allow the faster moving ethanol to escape. This allows you to detect more of the rum's desirable aromas while reducing some of the straight alcohol vapor exposure. For those of us who are “challenged” in the olfactory department, a little help is more than welcome. Note, these claims are reported to be backed by chemical analyses and numerous panel tastings. Second, the NEAT Glass does not tip over easily and thereby reduces spills and breakage. Third, you can stack it making it great for transport and storage in small spaces. Oh, and don't just take my word for it, it is now the preferred glass for the 2013 San Francisco World Spirits Competition.”

The citation for Mr. Feris's remarks is http://www.therumcollective.com/2013/03/neat-improving-way-you-drink-rhum.html.

M. SFWSC

Concerning the 2015 San Francisco World Spirits Competition Results, International news serivce Reuters in 2015 carried an SFWSC Press Release which stated, “For the first time in its 15-year run, the competition featured exclusively the NEAT glass. The new industry standard for spirits tasting, with a patented design, NEAT glasses are scientifically engineered with a compressed lip and flared rim to enhance the judging experience. “We have rigorously tested the NEAT Glass in comparative tastings with other spirits glasses,” says Blue. ‘It is the only glass that eliminates alcohol burn while enhancing aroma. It showcases all the nuance and complexity that the spirit's producer intended.’”

The citation for the SFWSC Press Release release is http://www.reuters.com/artricle/2015/03/31/idUSnMKWDlThha+1e8+MKW20150331

N. Stefan Van Eycken

Stefan Van Eycken is believed to be Chief Editor of the Tokyo Whisky Hub, a website for Whisky afficionados. Mr. Van Eycken stated in 2012, “I compared the NEAT glass with Glencairn and copita glasses, using some reference malts that I thought I knew inside out. The results were fascinating, if a little unsettling: the reference malts were anything but reference in the NEAT glass. The malts seemed to completely redefine themselves and I picked up notes that I'd never found before. They revealed themselves in a completely different light, with much more intensity and depth in terms of aroma and taste and with much more overall presence and definition. Treat yourself to a set of NEAT glasses and you'll see what I mean—you won't regret it.”

The citation for Mr. Van Eycken's remarks is http://www.nojatta.com/2012/08/a-neat-glass.html.

There is historical evidence related to unexpected result obtained with the present invention.

Media quotes, third party opinions regarding results and “obviousness” mentioned herein include authors, reviewers, scientists, executives and aficionados with varying years of experience in the spirits industry from production to retail and product evaluation.

“Obviousness” to one schooled in the art.

The inventors have spent more than a decade participating in and researching the art of tasting and nosing distilled spirits. Prior to the public introduction of the present invention the art of nosing and tasting distilled spirits (i.e., liquors such as whisky) did not have a specific method of controlling evaporation of ethanol spirits, other than the expedients of diluting the mixture with water, cooling the mixture with ice, and choking up the vapors in a narrow-mouthed glass. The inventors believe that the present invention, glassware having structure which dramatically improves a noser's and taster's ability to discern non-ethanol notes in the bouquet of the spirit being sampled, actually raised awareness in the art in a specific way that created the present understanding, an understanding which we term the scientific art of spirits nosing. The inventors believe that no one could have been schooled in this particular aspect the art, because it did not exist before the present invention taught persons of ordinary skill that such was feasible.

The state of mind among spirits tasters prior to the introduction of the present invention is summarized as follows:

During the scotch whisky invasion of the '60s, distillers and brand ambassadors found that they could not convince Americans to drink scotch neat (straight, no water, no ice or mix) because their noses could not handle the concentration of alcohol in a 40% ABV or higher spirit. The British and Europeans had been drinking whisky and cognac (over 40% ABV) for centuries and were quite accustomed to the burn, some even desiring and expecting it. Perceiving that the American resistance to consuming whisky was based on an intolerance of the strong odor of ethanol, the ambassadors instituted a campaign to reduce the evaporation of ethanol from the spirits in the glass at the time of tasting. This was accomplished in the following ways through marketing, and is still the recollected “art” of spirits drinkers unfamiliar to our invention:
Tell the drinker no to swirl the spirits in the glass (swirling accelerates evaporation and intensifies nose burn).
Use traditional tulip and chimney shape glassware having a very small openings.
Add water to slow the evaporation of nose burning ethanol.

Since the 1650's, addition of PbO (lead oxide) to the glass mixture, discovered by George Ravenscroft, lowered the melting temperature of glass thus enabling use of cheaper furnace fuels such as “sea” coal. The result was an interesting side effect that influenced the shape of glassware for future generations. PbO increases the refractive index of glass, so that it sparkles with rainbow hues and stands out in a candle-lit dining room. This spurred a huge market for leaded crystal in the courts of Europe. Eager for more beautiful table settings, even the water glasses sprouted stems to pick up more light in the bowl, leading to many accidental spills as plates were passed, and more difficulty as large bowl glassware was lifted by stem from table to mouth. Manufacturers noted that smaller glassware rim openings reduced collisions with other items being moved about on a crowded table, thereby reducing spills. Smaller openings also facilitated handling. Thus, manufacturers proclaimed stemmed, convergent rims to be the best glassware because of its beautiful light catching and easy handling. Around the 1960s, convergent rim glassware was described as the only glassware which placed all aromas right under the nose for detection, allowing no aromas to escape. Cups and vertical side glassware all but disappeared, and glass designers styling studios became all about the appearance of stemmed, convergent-rimmed glassware. Science was never a consideration in design, and the only acceptable science was that all aromas were available for detection if one had a well-defined sense of smell.

The belief that collecting all aromas at the nose so none escaped detection was assumed to be the unwavering axiom for alcohol beverage glassware, with no modifying postulates ever, eventually killing open mouth nosing and tasting vessels like the Scottish Quaich and French Tastevin which actually allowed more dissipation of alcohol. The axiom was so rigorously followed, that any other type of glassware was deemed unsuitable for drinking spirits. Thus, no other method was thought to be possible to separate molecules of ethanol. An apt analogy would be to the disbelief in cooking other than by direct contact, before the advent of microwave ovens.

Since the alcohol was understood to be an inseparable part of the mix of aromas from all alcohol spirits, there was no need in anyone's mind to approach separating ethanol molecules. After all, you can't just pick them out and remove them—you can't even see them. The following concepts were accepted as unequivocal truth until the present invention came along: (1) collect all the aromas at the nose, (2) learn to live with it in high alcohol spirits, or add ice or water, or dilute with a mixer such as soda or cola, and (3) don't swirl, because it just raises the alcohol nose burn from the spirit.

The Judgment in Paris in 1976 made the world aware that nose played an important part in the selection of quality at least in wine. Over the next four decades, notes regarding the aromatic characteristics of wine became the accepted sales and marketing descriptors, as well as all the cautions regarding avoidance of alcohol aromas so as not to be rendered aromatically helpless by the nose numbing effect of olfactory fatigue which hampers the enjoyment of aromatics by numbing the olfactory receptors with alcohol. In spite of these hints of nose awareness, the philosophy did not spread to the spirits industry, since wines were only 8-12% alcohol, and the problem was compounded by a spirit with 40% ABV or higher. No one knew or cared about solving an “unsolvable” problem.

Dimensional non-obviousness.

The dimensional requirements of the claimed invention are:

The distance from the liquid surface at maximum bowl diameter to the nose, when the lips are placed on the rim of the glass, is to not exceed 4.5 cm. with reference to previous art, it is noted that scaling Venon or Rosow so the nose fits in the sweet spot simply does not work because the nose is too far from the surface of the liquid.

The rim diameter of the glass to be approximately that required to position the nose in the sweet spot when the lips are placed on the rim, which is near the center of the glass.

The expansion volume defined by the flared edge of the glass to be of sufficient volume and low but sufficient vertical height to allow quick escape route of lighter ethanol molecules rather than a large and long vertical height which forces ethanol remixing with other aroma molecules, such as Rosow and Venon.

The evaporation chamber large enough volume to permit effective swirling of the liquid within the restrictions of the side curvature.

The evaporation area large enough to provide sufficient evaporation, and bowl side areas sufficient to provide large wetted surface evaporation.

Conceptual non-obviousness.

The concepts involved in the invention are:

Essential Concept 1: Squeezing and releasing the mixture of various sizes and weights of random molecules to divert the lighter molecules. This is an application of Newton's laws of motion and the definition of conservation of momentum. m₁ (v₁)=m₂ (v₂). Squeezing the various molecules closer together in a smaller space increases the incidence of molecular collision, making lighter molecules move faster. When released into the expansion volume, the lighter molecules travel faster, the most outward molecules dissipating along the rim flare or ramp, into the atmosphere, and away from the denser, slower moving molecules, thus creating the separation of different weights of molecules. The present invention uses this principle of physics applied to glassware to produce a specific result. We are unaware of any use of this principle in the design of glassware for nosing or tasting spirits, including whiskys, which contain well over 30 different, yet identifiable compounds in the evaporative aromas from light alcohols to heavy phenols and fatty acid ethyl esters.

Essential Concept 2: Evaporation is generally random, and if the evaporation volume to surface ratio is small enough, vapor pressure will drive the aromas through the orifice, provided it is not too small so as to be restrictive. This also means that the random evaporation of molecules must occur in an evaporation chamber large enough to promote evaporation, yet small enough to maintain evaporative pressure through the orifice. The inventors are unaware of any understanding of this concept by practioners of the art of nosing prior to the introduction of the present invention. The inventors are unaware of any specific consideration of maximizing evaporative surface and side bowl area as an advantageous feature in a spirits glass, prior to the introduction of the present invention. No one, to our knowledge, had a clue that large diameters would enhance evaporation, especially when the direction was to refrain from swirling, because enhanced evaporation was undesirable (enhancing evaporation only burned your nose with convergent rim glassware, and was therefore discouraged).

Essential Concept 3: Once the aroma mixture has been activated by compression in the orifice, there must be a clear and workable escape route for the offending light aromas. Any prior art which at first appears to embody the concept of squeeze and release such as Rosow and Venon also fails in allowing the alcohol to escape by having nearly vertical sides after the aromas pass through the neck. This means the alcohol which had a chance to separate now remixes with the other aromas as it is gradually pushed to the top rim of the glass, finding no escape route and bouncing off the vertical walls remixing after separation. Existing spirits nosing glassware have been of the chimney and tulip shape, which provide no separation or escape path for the ethanol. Even the Walsh reference glass has no clear escape route for the alcohol.

Essential Concept 4: Detecting all available molecules in the evaporated aromas is highly dependent on vertical height. The taller the glass, the higher the concentration of light molecules, as heavier molecules work their way back into the liquid never to be detected in high enough concentration for human recognition. To the inventors' knowledge, it never has been obvious to spirits glass designers that glass height can be too tall to get most of the aromas. If it had been obvious, the commonly used glassware would not be tall as it is today in the widely accepted convergent rim copita and chimney shaped Glencairn nosing glasses.

Essential Concept 5: Liquid evaporates quicker from the more vertical wetted hydrophobic side surfaces of a vessel than from the surface of a liquid. In fact, the immiscibility of alcohol and water, forming the “legs” or “tears” of liquid in the vessel are enhancing evaporation to over three times more than the surface of the static liquid in the bowl. As the liquid surface at the bowl is maximized by increasing the diameter to the limit for ergonomic handling convenience, the side bowl area, much more critical to evaporation was increased accordingly, providing a multiple of available evaporation if the liquid is swirled prior to sampling as specified in the method.

Essential Concept 6: Scientific verification that alcohol is removed from the sweet spot of the invention and is NOT removed from other standard spirits glasses. The inventors know of no other glass company who has tested their glassware to determine where the alcohol goes in a particular design or shape, and feel this is because, to the best of their knowledge, no one has ever believed that a scientific approach is necessary for anything as simple as glassware design. The Chemistry Department at UNLV performed GCMS studies late in 2011 under the guidance of Professor Steinberg comparing the instant invention to the Glencairn, the standard copita, and a vertical sided “rocks” tumbler and determined conclusively that alcohol aroma is significantly less concentrated in the center of the inventive glass than in other shapes. UNLV subsequently issued an article detailing the collaboration in the school magazine. Although gas chromatography mass spectrometry studies are frequently used to determine composition of distilled spirits, we are unaware of any earlier studies to differentiate glassware aroma dissipation properties in the design of glassware for tasting or nosing. The inventors are unaware of any other glassware company proving those companies' glassware's performance through GCMS, the conventional belief being that it is a static test and easily dismissed as not representative for a dynamic drinking experience. However, as long as there is spirit in the glass, the tests conclusively indicated that significantly lower concentrations of alcohol consistently were detected in the sweet spot area of the glass in accordance with the present invention.

Given the state of the art of nosing spirits prior to invention disclosure, the inventors find it difficult to entertain any ideas of obviousness which sums up our nearly 9 years of research into a scientific art the inventors created where none was ever acknowledged or existed. Just not obvious.

There is historical evidence relevant to long-felt and un-met need.

Evaluation and judging in the spirits industry have changed in important ways, indicating the commercial embodiment of the present invention has met a long-felt and un-met need:

Since 2012, product awards and competition medals have been awarded to the invention, as six major spirits competitions have adopted the glass as their official nosing, tasting and judging glass. These are enumerated on the “Awards” page of the website www.theneatglass.com. In addition, in 2012, Vegas Seven magazine Awarded the invention their “Best New Bar Tool” award.

Medals for quality won by spirits in the world renowned San Francisco World Spirits Competition, the Miami Rum Festival, the San Diego Spirits Festival, the New York World Spirits Competition, The Craft Spirits Awards and the SIP Awards in Los Angeles, and this year the Irish Whiskey Awards in Dublin, have all been evaluated in the commercial embodiment of the present invention. This is a testimonial to the acceptance of the new way, including the method of tasting, the industry is adopting to taste and evaluate spirits using the present invention.

Having been present at the major spirits competitions using our invention, the inventors continue to categorically ask the judges how they feel after the experience, and whether they experienced olfactory fatigue at anytime during the tasting. The inventors have never had a judge say that he or she experienced olfactory fatigue during the 4-8 hour events, some lasting two days. Event co-ordinators also report that the tastings move faster than they had with other glassware. They feel that this is due to the fact that flights can be prepoured with the cap system, and the judges are much more definitive about their evaluations when they don't have to nose through the alcohol aromas to find the characteristic aromas of the spirit.

In 2013 during the Rum Renaissance Festival judging and competition event in Miami, Fla., the inventors poured the first flight of rums to be evaluated and left the room to get lunch. Returning in about 30 minutes, the inventors noticed the whole room was filled with the sweet odor of rum. Initially thinking someone had broken a bottle and failed to clean up, the inventors eventually discovered that the invented glass was highly efficient at displaying spirit aromas, and had to cover the glasses and air out the room in order not to confuse the sampling aromas during judging. This prompted the adoption of a special disposable, sanitary cap which the inventors use in all judging competitions to keep aromas separate, with the caution to the judges to keep all samples covered except the specific one they are currently evaluating. This is a testimonial to the efficiency of the glass, and the inventors have noted that even minor competitions which do not yet use the glass have adopted the paper cap to isolate sample aromas. An unexpected result.

Sales to distillery gift shops with logo identification are steadily on the rise, and many of the distillers use the glass in the distillery and chais to barrel taste the progress of their spirits, assess quality and aroma development as their spirits age, and as a diagnostic tool to determine proper timing of the head and tail cuts of the distillation, biological barrel contamination, and as a blending tool. In addition, many of them state that the glass is used in their tasting rooms and increases sales of their spirits to the walk-in tourist and visitor.

The glass is sold to essence manufacturers as a diagnostic tool, olive oil companies as a sales tool, and we are currently investigating the tea and perfume markets for applicability. These are unexpected results due to the enhanced aroma display of the sweet spot, and dissipation of lighter aromas away from the nose.

1-13. (canceled)

14. A nosing vessel, comprising:
a bowl;
a convergent side portion above said bowl;
a maximum-diameter portion defined between said convergent side portion and said bowl;
said bowl having capacity to hold sufficient liquid for tasting when filled to the level of said maximum-diameter portion;
a divergent side portion above said convergent side portion,
a neck portion defined between said divergent side portion and said convergent side portion, said neck portion having a diameter defined where said neck portion is at its narrowest, an orifice being defined at said neck portion;
said divergent side portion having a rim, said rim being substantially equal in diameter to said maximum diameter portion, said divergent side portion flaring outwardly and upwardly at a substantially constant angle from said neck portion to said rim and placing said rim at a height and radius to deliver liquid in a wide sheet waterfall to a person's mouth, tongue and palate during transfer to the palate for liquid sampling;
said divergent side portion being dimensioned such that a person who inhales nasally, while holding said bowl so that said rim is level and said rim is approximated to his/her lips, inhales selectively from proximate said orifice, above said rim, proximate a central vertical axis defined relative to said rim and said bowl;
said rim and said maximum diameter portion being spaced apart vertically a distance of no more than 4.5 cm;
said rim and said neck portion being spaced apart vertically a distance of no more than 3.0 cm.

15. The nosing vessel of claim 14, wherein said rim and said neck portion are spaced apart vertically a distance of no more than 2.0 cm.

16. The nosing vessel of claim 14, comprising alternative hand-holding structure selected from among the group including:
a stem and foot affixed beneath said bowl;
a cup handle affixed to a side portion of said bowl;
a protrusion affixed to a side portion of said bowl;
an appendage affixed to a side portion of said bowl;
a handle affixed to a side portion of said bowl; and
an ear affixed to a side portion of said bowl.

17. The nosing vessel of claim 14, comprising a removable cover located atop the rim.

18. The nosing vessel of claim 14, comprising a wall outside said bowl insulating said bowl from heating or cooling external contact.

19. The nosing vessel of claim 14, comprising a fluid mixing structure inside said vessel, said fluid mixing structure being selected from among the group including a hump, a punt, a kick, bumps, valleys, troughs, dams, cuts, and relief patterns.

20. The nosing vessel of claim 14, comprising a decorative element selected from among the group including color co-ordination, engraving, grinding, cutting, etching, sample identification, decal, transfer, and marking.

21. A method of using a vessel to deliver a mixture of vapors from a liquid to a person's nose in a controlled manner, including the steps of:
providing a vessel as set forth in claim 14;
adding to said vessel a volume of the liquid not sufficient to fill said bowl beyond said maximum diameter portion;
allowing vapors evaporating from the volume of liquid in said bowl to collect in a volume above the volume of liquid and surrounded by said converging side portion;
allowing the vapors to emerge through said neck portion into a volume above said neck portion and surrounded by said diverging side portion; and
using said rim to locate the person's lips on said vessel while locating the person's nose in the vapors emerging above said neck portion.

22. The method of claim 21, including the step of swirling the volume of liquid in said bowl.

23. The method of claim 21, including the step of warming the volume of liquid in said bowl by contacting said bowl and said converging side portion with a person's warm hand.

24. The method of claim 21, including the step of holding said vessel by said neck portion while avoiding contact with said bowl or said converging side portion.

25. The method of claim 21, including the step of placing a cover over said rim after adding the volume of liquid to said vessel.

26. The method of claim 21, including a step whereby the person whose lips are located on said vessel tilts his/her head slightly forward or back relative to said vessel to adjust the position of the person's nose in the vapors emerging above said neck portion.

27. A method of using a vessel to enable a person to selectively sniff vapors in a mixture of vapors emerging from a liquid, including the steps of:
providing a vessel as set forth in claim 14;
adding to said vessel a volume of the liquid not sufficient to fill said bowl beyond said maximum diameter portion;
allowing vapors evaporating from the volume of liquid in said bowl to collect in a volume above the volume of liquid and surrounded by said converging side portion;
waiting while more rapidly diffusing vapors emerge through said neck portion into a volume above said neck portion and surrounded by said diverging side portion; and
after waiting, sniffing less rapidly diffusing vapors by using said rim to locate the person's lips on said vessel while locating the same person's nose in the vapors emerging above said neck portion.

28. The method of claim 27, including a step whereby the person whose nose is located in the vapors emerging above said neck portion tilts his/her head slightly forward or back relative to said vessel to adjust the position of his/her nose in those vapors.

29. The nosing vessel of claim 14, wherein
a maximum depth is measured vertically from the bottom of said bowl to said rim; and
said maximum-diameter portion has a diameter exceeding said maximum depth.

30. The nosing vessel of claim 29, wherein
a neck height is measured vertically from the bottom of said bowl to said neck portion; and
said neck height is 0.7 times said maximum depth.

31. The nosing vessel of claim 15, wherein
a maximum depth is measured vertically from the bottom of said bowl to said rim; and
said maximum-diameter portion has a diameter exceeding said maximum depth.

32. The nosing vessel of claim 31, wherein
a neck height is measured vertically from the bottom of said bowl to said neck portion; and
said neck height is 0.7 times said maximum depth.
